(19) United States
(12) Patent Application Publication
(10) Pub. No.: US 2023/0398996 A1
(43) Pub. Date: Dec. 14, 2023

(54) INFORMATION PROCESSOR, INFORMATION PROCESSING METHOD, AND RECORDING MEDIUM

(71) Applicant: TOYOTA JIDOSHA KABUSHIKI KAISHA, Toyota-shi Aichi-ken (JP)

(72) Inventors: Jun Hattori, Chiyoda-ku Tokyo-to (JP); Gentaro Kogano, Chiyoda-ku Tokyo-to (JP)

(73) Assignee: TOYOTA JIDOSHA KABUSHIKI KAISHA, Toyota-shi Aichi-ken (JP)

(21) Appl. No.: 18/203,786

(22) Filed: May 31, 2023

(30) Foreign Application Priority Data
Jun. 10, 2022 (JP) 2022-094173

(51) Int. Cl. B60W 40/09; B60W 40/105; B60W 40/114; B60W 30/18

(52) U.S. Cl. CPC B60W 40/09; B60W 40/105; B60W 40/114; B60W 30/18159; B60W 2520/14; B60W 2552/53; B60W 2556/10

(57) ABSTRACT

An information processor includes: a first information acquisition unit that acquires section position information for identifying the position of a first section on a traveling lane and the position of a second section on an oncoming lane; a second information acquisition unit that stores, as history information, the history of driving characteristic parameters when traveling through the intersection; a driver's vehicle position calculation unit that sequentially calculates the driver's vehicle position information when traveling through the intersection; a section determination unit that determines which of the first section and the second section the driver's vehicle position is located; and an extraction unit that extracts a specific driving characteristic parameter corresponding to at least one of the first section and the second section from the history information based on the result of the determination by the section determination unit.

### CROSS-REFERENCE TO RELATED APPLICATIONS

This application claims priority to Japanese Patent Application No. 2022-94173 filed on Jun. 10, 2022, incorporated herein by reference in its entirety.

BACKGROUND

### 1. TECHNICAL FIELD

The present disclosure relates to an information providing device that handles driving characteristic parameters used in the evaluation of driving behavior.

### 2. DESCRIPTION OF THE RELATED ART

Japanese Unexamined Patent Application Publication No. 2021-051341 discloses a technique for acquiring driving characteristic parameters representing the driving characteristics of a driver before and after passing a stop line before an intersection and evaluating driving behavior with respect to the stop line using the acquired driving characteristic parameters.

In countries with left-hand traffic, when passing through an intersection by turning right, the driving operation by the driver can vary greatly between a traveling lane for the traveling of the driver's vehicle and an oncoming lane at the intersection. The same is true for passing through an intersection by turning left in countries with right-hand traffic. Therefore, in order to properly evaluate driving behavior at the time of turning right or left at an intersection, it is desirable to be able to separately obtain driving characteristic parameters for each of the traveling lane and the oncoming lane at the intersection.

### SUMMARY

In this background, a purpose of the present disclosure is to provide a technique for separately obtaining driving characteristic parameters for each of a traveling lane and an oncoming lane at an intersection.

One embodiment of the present disclosure relates to an information processor. This information processor includes: a first information acquisition unit that acquires section position information for identifying the position of a first section on a traveling lane for the traveling of a driver's vehicle and the position of a second section on an oncoming lane at an intersection located in front of the driver's vehicle; a second information acquisition unit that sequentially acquires vehicle behavior information regarding the behavior of the driver's vehicle when traveling through the intersection and stores, as history information, the history of driving characteristic parameters representing the driving characteristics of the driver included in the sequentially acquired vehicle behavior information; a driver's vehicle position calculation unit that sequentially calculates the driver's vehicle position information for identifying the driver's vehicle position when traveling through the intersection based on the vehicle behavior information; a section determination unit that determines which of the first section and the second section the driver's vehicle position identified by the driver's vehicle position information is located, based on the section position information; and an extraction unit that extracts a specific driving characteristic parameter corresponding to at least one of the first section and the second section from the history information based on the result of the determination by the section determination unit.

The information processor may include an evaluation unit that evaluates the driving behavior of the driver based on the driving characteristic parameter extracted by the extraction unit. This evaluation unit may perform the evaluation using a trained model obtained through machine learning.

Another embodiment of the present disclosure relates to an information processing method. This information processing method is an information processing method executed by a computer, including: acquiring section position information for identifying the position of a first section on a traveling lane for the traveling of a driver's vehicle and the position of a second section on an oncoming lane at an intersection located in front of the driver's vehicle; sequentially acquiring vehicle behavior information regarding the behavior of the driver's vehicle and storing, as history information, the history of driving characteristic parameters representing the driving characteristics of the driver included in the sequentially acquired vehicle behavior information; sequentially calculating the driver's vehicle position information for identifying the driver's vehicle position where the driver's vehicle exists when traveling through the intersection based on the vehicle behavior information; determining which of the first section and the second section the driver's vehicle position identified by the driver's vehicle position information is located, based on the section position information; and extracting a specific driving characteristic parameter corresponding to at least one of the first section and the second section from the history information based on the result of the determination in the determining.

Another embodiment of the present disclosure relates to a recording medium having embodied thereon a program. This recording medium includes computer-implemented modules including: a module that acquires section position information for identifying the position of a first section on a traveling lane for the traveling of a driver's vehicle and the position of a second section on an oncoming lane at an intersection located in front of the driver's vehicle; a module that sequentially acquires vehicle behavior information regarding the behavior of the driver's vehicle and stores, as history information, the history of driving characteristic parameters representing the driving characteristics of the driver included in the sequentially acquired vehicle behavior information; a module that sequentially calculates the driver's vehicle position information for identifying the driver's vehicle position where the driver's vehicle exists when traveling through the intersection based on the vehicle behavior information; a determination module that determines which of the first section and the second section the driver's vehicle position identified by the driver's vehicle position information is located, based on the section position information; and a module that extracts a specific driving characteristic parameter corresponding to at least one of the first section and the second section from the history information based on the result of the determination by the determination module.

### BRIEF DESCRIPTION OF THE DRAWINGS

Embodiments will now be described, by way of example only, with reference to the accompanying drawings that are meant to be exemplary, not limiting, and Embodiments will now be described, by way of example only, with reference to the accompanying drawings that are meant to be exemplary, not limiting, and wherein like elements are numbered alike in several figures, in which:

FIG. 1 is a diagram schematically showing a utilization scene of an information processor according to an embodiment;

FIG. 2 is a block diagram showing the configuration of a vehicle system according to the embodiment;

FIG. 3 is an illustration diagram of the method of calculating driver's vehicle position information in an intersection;

FIG. 4 is an illustration diagram of a driver's vehicle position and a width direction distance Sx in the first section during a right turn;

FIG. 5 is an illustration diagram of a driver's vehicle position and a width direction distance Sx in the second section during a right turn;

FIG. 6 is an illustration diagram of a driver's vehicle position and a width direction distance Sx during a left turn;

FIG. 7 is a table showing driving characteristic parameters to be extracted by an extraction unit; and

FIG. 8 is a flowchart showing a parameter extraction process and a driving behavior evaluation process.

### DETAILED DESCRIPTION

Various embodiments now will be described. The embodiments are illustrative and are not intended to be limiting.

Embodiments will be explained in the following. Like numerals represent like constituting elements, and duplicative explanations will be omitted. For the sake of ease of explanation, constituting elements are appropriately omitted, enlarged, or reduced in the figures. The figures shall be viewed in accordance with the orientation of reference numerals.

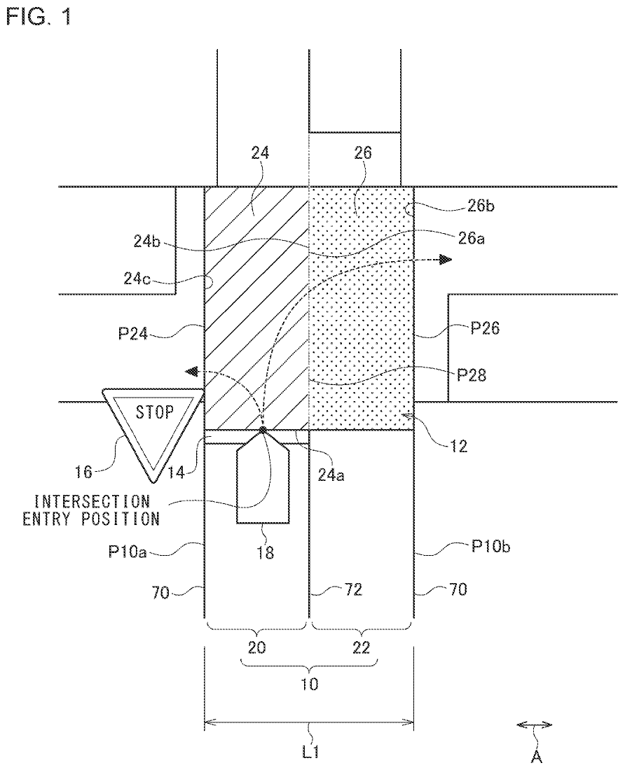

FIG. 1 is a diagram schematically showing a utilization scene of an information processor according to the present embodiment. The information processor is used when there is an intersection 12 with a temporary stop regulation (hereinafter, also referred to as a temporary stop intersection 12) on a driver's vehicle traveling path 10 for the traveling of the driver's vehicle. There is a stop line 14 as a road marking before the temporary stop intersection 12, and there is a temporary stop sign 16 as a traffic sign near the stop line 14.

The driver's vehicle traveling way 10 is composed of a traveling lane 20 for the traveling of the driver's vehicle 18 and an oncoming lane 22 for the traveling of oncoming cars. The number of traveling lanes 20 and the number of oncoming lanes 22 are singular in this case. However, the number of traveling lanes 20 and the number of oncoming lane 22 may be plural regardless of the number of lanes of each other. Hereinafter, the width direction of the driver's vehicle traveling way 10 is also referred to as a width direction A. The width direction A is also a direction orthogonal to the direction of travel in which the vehicle should proceed on the traveling lane 20.

An explanation will now be given regarding a mechanism for separately acquiring driving characteristic parameters respectively corresponding to the traveling lane and the oncoming lane 22 at the intersection 12 when passing through the intersection 12 by turning right or left. In order to achieve this, the intersection 12 is handled as the intersection 12 is divided into two sections 24 and 26. The two sections 24 and 26 are a first section 24 on the traveling lane 20 and a second section 26 on the oncoming lane 22. The first section 24 is located at a position obtained by extending the traveling lane 20 located before the intersection 12 to the intersection 12. The second section 26 is located at a position obtained by extending the oncoming lane 22 before the intersection 12 to the intersection 12.

The first section 24 includes an entrance 24a through which the vehicle passes when entering the first section 24, a first exit 24b through which the vehicle passes when exiting the first section 24 by turning right, and a second exit 24c through which the vehicle passes when exiting the first section 24 by turning left. The entrance 24a of the first section 24 according to the present embodiment is provided at a position obtained by extending an intersection entry position (described later) in the width direction A in the traveling lane 20. The first exit 24b is provided at a boundary position P28 between the two sections 24 and 26 (hereinafter, also referred to as a section boundary position P28), and the second exit 24c is provided at an end position P24 on the outer side of the first section 24 in the width direction. The second section 26 includes an entrance 26a through which the vehicle passes when entering the second section 26 and a second exit 26b through which the vehicle passes when exiting the second section 26. The entrance 26a is provided at the section boundary position P28, and the second exit 26b is provided at an end position P26 on the outer side of the second section 26 in the width direction.

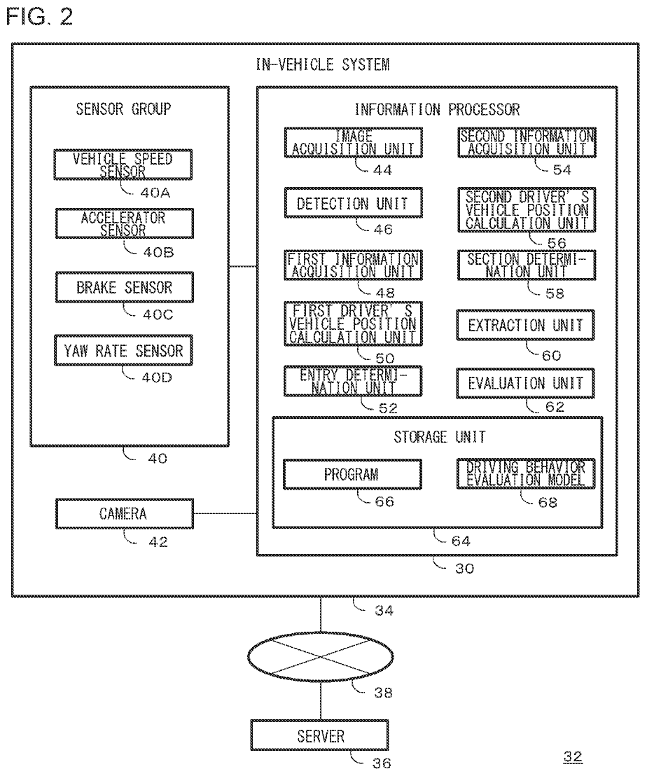

FIG. 2 is a block diagram showing the configuration of a vehicle system 32 in which an information processor 30 according to the present embodiment is used. The vehicle system 32 includes an in-vehicle system 34 and a server 36. The in-vehicle system 34 is mounted on the driver's vehicle, which is a motor vehicle. The in-vehicle system 34 can communicate wirelessly with the server 36 via a network 38.

The in-vehicle system 34 includes a sensor group 40 and a camera 42, in addition to the information processor 30. The information processor 30, the sensor group 40, and the camera 42 are connected to one another via an in-vehicle network such as Control Area Network (CAN).

The sensor group 40 is mounted on the driver's vehicle. The sensor group 40 includes a vehicle speed sensor 40A for detecting the vehicle speed of the driver's vehicle, an accelerator sensor 40B for detecting the amount of acceleration, which is the amount of depression of the accelerator pedal, a brake sensor 40C for detecting the amount of braking, which is the amount of depression of the brake pedal, and a yaw rate sensor 40D for detecting the yaw rate of the driver's vehicle. Each sensor of the sensor group 40 periodically detects various physical quantities and outputs the detected physical quantities to the information processor 30 via the in-vehicle network.

The camera 42 is mounted on the driver's vehicle. The camera 42 periodically captures an image of an area in front of the driver's vehicle at a predetermined frame rate (e.g., 30 fps) and sequentially outputs the captured image to the information processor 30 via the in-vehicle network.

The information processor 30 is composed of a combination of a central processing unit (CPU), read only memory (ROM), random access memory (RAM), etc., in terms of hardware. Further, the information processor 30 is realized by a computer program, etc., in terms of software.

The figure illustrates functional blocks implemented by the cooperation of those components. It will be appreciated to a skilled person that these functional blocks may be implemented in a variety of forms by a combination of hardware and software.

The information processor 30 includes an image acquisition unit 44, a detection unit 46, a first information acquisition unit 48, a first driver's vehicle position calculation unit 50, an entry determination unit 52, a second information acquisition unit 54, a second driver's vehicle position calculation unit 56, a section determination unit 58, an extraction unit 60, an evaluation unit 62, and a storage unit 64.

The storage unit 64 stores a program 66 and a driving behavior evaluation model 68. The program 66 is used to perform a parameter extraction process for extracting specific driving characteristic parameters when making a right or left turn at the intersection 12 and a driving behavior evaluation process for evaluating driving behavior using the extracted driving characteristic parameters. The information processor 30 performs the parameter extraction process and the driving behavior evaluation process by executing the program 66 read from the storage unit 64 and executing the functions of the image acquisition unit 44, etc. The parameter extraction process is realized by the functions of the image acquisition unit 44, the detection unit 46, the first information acquisition unit 48, the first driver's vehicle position calculation unit 50, the entry determination unit 52, the second information acquisition unit 54, the second driver's vehicle position calculation unit 56, the section determination unit 58, and the extraction unit 60. The driving behavior evaluation process is realized by the function of the evaluation unit 62.

The driving behavior evaluation model 68 uses multiple types of driving characteristic parameters corresponding to the respective driving behaviors of a right turn and a left turn as explanatory variables and uses index values for evaluating the driving behaviors as objective variables. The driving behavior evaluation model 68 includes a first driving behavior evaluation model corresponding to a right-turn driving behavior and a second driving behavior evaluation model corresponding to a left-turn driving behavior. The driving behavior evaluation model 68 is expressed, for example, by the following expression. The second driving behavior evaluation model corresponding to a left turn with eight types of driving characteristic parameters (x1 to x8) serving as explanatory variables will be described as an example. Also, an example will be described in which an index value for evaluating the degree of safety of driving behavior is used as an objective variable. By inputting a driving characteristic parameter serving as an explanatory variable into the driving behavior evaluation model 68, an index value serving as an objective variable is output, and the degree of safety of driving behavior can be evaluated based on the index value. In this case, a1 to a8 and a0 are coefficients that are calculated by machine learning described later.

(Degree of safety)=a1*x1+a2*x2+a3*x3+a4*x4+a5*x5+a6*x6+a7*x7+a8*x8+a0

The driving behavior evaluation model 68 is, for example, a trained model generated by machine learning. Machine learning for generating the trained model is performed, for example, by supervised learning on the server 36 using a training data set including multiple pieces of training data. The training data associates index values that evaluate the driver's cognitive level with multiple types of driving characteristic parameters obtained when the driver performs a specific driving behavior (left or right turn). The index values for evaluating the cognitive level are, for example, measurement values obtained by the driver performing a cognitive ability test such as trait making test (TMT). The training data set contains multiple pieces of training data on multiple drivers. Machine learning is achieved, for example, by performing multiple regression analysis where the index values for evaluating the cognitive level serve as objective variables and multiple types of driving characteristic parameters serve as explanatory variables while using the training data set so as to calculate the coefficients of the driving behavior evaluation model 68. The coefficients of the driving behavior evaluation model 68 serving as a trained model are calculated values obtained by such machine learning. The driving behavior evaluation model 68 generated as a trained model on the server 36 is stored in the storage unit in the server 36, then transmitted from the server 36 to the information processor 30 of the in-vehicle system 34, and stored in the storage unit 64 therein.

The image acquisition unit 44 sequentially acquires images of an area in front of the driver's vehicle by the camera 42. The detection unit 46 performs an object detection process for detecting the presence or absence of objects such as a stop line 14 in front of the driver's vehicle 18. The detection unit 46 may perform the object detection process using various object detection methods including known methods. The detection unit 46 according to the present embodiment performs the object detection process based on images acquired by the image acquisition unit 44. In this case, the object detection methods may be achieved using, for example, pattern matching or the like in addition to Regions with Convolutional Neural Networks (R-CNN), You Only Look Once (YOLO), Single Shot Multibox Detector SSD (SSD), etc., which use machine learning. In addition, the detection unit 46 may detect the presence or absence of objects in front of the driver's vehicle using map information stored in the car navigation system and the driver's vehicle position information estimated by GPS.

The detection unit 46 detects the intersection 12 in front of the driver's vehicle 18 by the object detection process. The detection unit 46 according to the present embodiment detects the presence of the intersection 12 when detecting the stop line 14 and the temporary stop sign 16 located in front of the driver's vehicle 18. In addition to this, the detection unit 46 detects left and right roadway width lines 70 (see FIG. 1) as road surface markings on the respective sides of the width direction of the vehicle's traveling way 10 before the intersection 12. Further, if there is a center line 72 serving as a road surface marking between the traveling lane 20 and the oncoming lane 22 before the intersection 12, the detection unit 46 detects the center line 72.

When the first information acquisition unit 48 detects the intersection 12 located in front of the driver's vehicle, the first information acquisition unit 48 acquires section position information for identifying the position of the first section 24 and the position of the second section 26 at the intersection 12.

FIG. 1 is now referred to. The section position information includes information for identifying the end positions P24 and P26 on the outer side in the width direction of the section 24 and 26, respectively. The end position P24 of the first section 24 is identified as a position obtained by extending to the intersection 12 one end position P10a on the traveling lane 20 side of the driver's vehicle traveling way 10 located before the intersection 12. The end position P26 of the second section 26 is identified as a position obtained by extending to the intersection 12 the other end position P10b on the oncoming lane 22 side of the driver's vehicle traveling way 10 located before the intersection 12. The positions P10a and P10b at the respective ends of the driver's vehicle traveling way 10 are identified, for example, as the respective positions of the left and right roadway width lines 70 detected by the detection unit 46. The information for identifying the respective end positions P24 and P26 of the sections 24 and 26 serves as information for identifying both end positions P10a and P10b of the driver's vehicle traveling way 10.

The section position information includes information for identifying the section boundary position P28 of the first section 24 and the second section 26. If there is a center line 72 between the traveling lane 20 and the oncoming lane 22, the section boundary position P28 is identified as a position obtained by extending the center line 72 to the intersection 12. In this case, the information for identifying the section boundary position P28 is information indicating the position of the center line 72.

If there is no center line 72 between the traveling lane 20 and the oncoming lane 22, the section boundary position P28 is identified as a position obtained by extending a position bisecting the width L1 of the driver's vehicle traveling way to the intersection 12. In this case, the information for identifying the section boundary position includes information indicating both end positions P10a and P10b of the driver's traveling way 10 and the width L1 of the driver's vehicle traveling way 10.

The first information acquisition unit 48 according to the present embodiment acquires the section position information (information indicating the respective positions of both end positions P10a and P10b, the width L1, and the center line 72 of the driver's vehicle traveling way by analyzing images that are sequentially acquired by the image acquisition unit 44. Alternatively, the first information acquisition unit 48 may acquire the section position information using the map information stored in the car navigation system and the driver's vehicle position information estimated by GPS.

The first driver's vehicle position calculation unit 50 calculates the distance in the width direction from the section boundary position P28 to the driver's vehicle position before entering the intersection 12. The driver's vehicle position in this case is identified, for example, by the intersection of the left and right center positions of the driver's vehicle 18 and the front end of the driver's vehicle 18. The first driver's vehicle position calculation unit 50 according to the present embodiment calculates the distance in the width direction from the section boundary position P28 to the driver's vehicle position by image analysis using the images acquired by the image acquisition unit 44. Alternatively, the first driver's vehicle position calculation unit 50 may calculate the distance in the width direction from the section boundary position P28 to the driver's vehicle position using the map information in the car navigation system and the driver's vehicle position information estimated by GPS.

The entry determination unit 52 determines whether or not the driver's vehicle has entered the intersection 12 located in front of the driver's vehicle 18. The entry determination unit 52 determines whether or not the driver's vehicle has entered the intersection 12 based on the images acquired by the image acquisition unit 44 using the stop line 14 located in front of the driver's vehicle 18. More specifically, the entry determination unit 52 determines that the driver's vehicle has passed the stop line 14 and entered the intersection 12 when an image is acquired that shows that the stop line 14 detected by the detection unit 46 has disappeared out of the field of view of the camera 42. When the detected stop line 14 can be detected continuously within the field of view of the camera 42, the entry determination unit 52 determines that the driver's vehicle has not passed the stop line 14 and has not entered the intersection 12. The expression “out of the field of view of camera 42” in this case includes not only the range outside the angle of view of the camera 42, but also a blind area range that is within the angle of view of the camera 42 and hidden by the driver's vehicle. Alternatively, the entry determination unit 52 may determine whether or not the driver's vehicle has entered the intersection 12 based on the map information in the car navigation system and the driver's vehicle position information estimated by GPS. At this time, the driver's vehicle may be determined to have entered the intersection 12 when the driver's vehicle position estimated by the driver's vehicle position information passes the stop line 14 identified by the map information.

The second information acquisition unit 54 sequentially acquires vehicle behavior information regarding the behavior of the driver's vehicle when traveling through the intersection 12. The vehicle behavior information according to the present embodiment includes the vehicle speed, the amount of acceleration, the amount of braking, and the yaw rate of the driver's vehicle. The vehicle behavior information is sequentially output from the sensor group 40 as CAN data via the vehicle network. The expression “when traveling through the intersection 12” in this case refers to, for example, the period of time from when the driver's vehicle is determined to have entered the intersection 12 by the entry determination unit 52 to when the driver's vehicle is determined to have exited the intersection 12 by the section determination unit 58 described later.

The second information acquisition unit 54 stores the history of multiple types of driving characteristic parameters included in the vehicle behavior information sequentially acquired when traveling through the intersection 12 as history information. The history information represents a history of the multiple types of driving characteristic parameters acquired for each unit time during a period from the time when the driver's vehicle is determined to have entered the intersection 12 by the entry determination unit 52 to the time when the driver's vehicle is determined to have exited the intersection 12 by the section determination unit 58. The history information is information that links the multiple types of driving characteristic parameters acquired for each unit time with the respective acquisition times of the multiple types of driving characteristic parameters. The multiple types of driving characteristic parameters in this case refer to the vehicle speed, the amount of acceleration, and the amount of braking of the driver's vehicle. The unit time in this case is set to the time length of one frame of the camera 42 (inverse of the frame rate). This unit time is not limited to this and may be set to another length of time.

When it is determined that the driver's vehicle has entered the intersection 12 by the entry determination unit 52, the second driver's vehicle position calculation unit 56 sequentially calculates the driver's vehicle position information for identifying the driver's vehicle position where the driver's vehicle exists when traveling through the intersection 12 based on the vehicle behavior information. The second driver's vehicle position calculation unit 56 sequentially calculates the distance in the width direction from the entry position to the intersection 12 (hereinafter referred to as intersection entry position) to the driver's vehicle position as the driver's vehicle position information. This intersection entry position is, for example, a position where the front end of the driver's vehicle 18 is located when the driver's vehicle is determined to have entered the intersection 12 by the entry determination unit 52. This intersection entry position is identified as, for example, a position that is away from the section boundary position P28 by the distance in the width direction calculated most recently by the first driver's vehicle position calculation unit 50 toward the traveling lane 20 when the driver's vehicle is determined to have entered the intersection 12 by the entry determination unit 52. The second driver's vehicle position calculation unit 56 calculates the driver's vehicle position within the intersection 12 for each acquisition time (unit time) of the driving characteristic parameters stored in the history information.

The second driver's vehicle position calculation unit 56 calculates the distance in the width direction from the intersection entry position to the driver's vehicle position in the following flow based on the vehicle speed and yaw rate of the driver's vehicle serving as the vehicle behavior information.

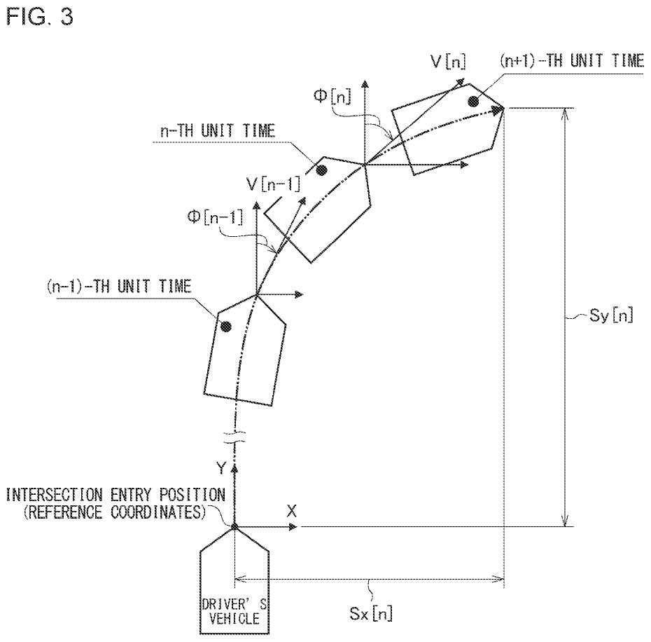

FIG. 3 is an illustration diagram of the method of calculating the driver's vehicle position information in an intersection. The intersection entry position is used as reference coordinates. The width direction A is defined as an X direction, and a traveling direction on the traveling lane 20 is defined as a Y direction. The positive direction in the X direction is a right turn direction viewed from the reference coordinates, and the positive direction in the Y direction is a traveling direction viewed from the reference coordinates.

The vehicle speed vector of the driver's vehicle 18 at a position where the driver's vehicle has traveled for n unit time from the reference coordinates is denoted as V[n], and the angle of the driver's vehicle 18 with respect to the Y-direction axis is denoted as Φ[n]. As described above, the unit time in this case is the time length of one frame of the camera 42. At this time, the following Expression (1) is established, where YR[n] represents the yaw rate at the n-th unit time (deg/sec) and Δn represents a time step per unit time (sec). In this case, Δn represents the time length of one frame. Using an integrated value obtained by integrating an angle change amount (YR[n]) per unit time from the time of entry into the intersection 12 until a specific time (time in n-th unit time), the angle Φ[n] at the specific time is calculated.

Φ[n]=Φ[n−1]+Δn×YR[n] (1)

Given that the distance moved in the direction of the vehicle speed vector V[n] of the driver's vehicle from the driver's vehicle position at the n-th unit time to the driver's vehicle position at the (n+1)-th unit time is denoted as S_{frame} [n], the following Expression (2) is established.

S_{frame}[n]=Δn×V[n] (2)

The distance in the X direction with respect to the reference coordinates at the n-th unit time is denoted as Sx[n], and the distance in the Y direction is denoted as Sy[n]. This Sx[n] represents the distance in the width direction at a specific time (time in n-th unit time). In this case, Sx[n] and Sy[n] can be expressed by the following Expressions (3) and (4), respectively. At the reference coordinates, n=0 is established, and Sx[0]=0 and Sy[0]=are established.

Sx[n]=Sx[n−1]+S_{frame}[n]X sinΦ[n] (3)

Sy[n]=Sy[n−1]+S_{frame}[n]X cosΦ[n] (4)

The expression “S_{frame} [n]×sin Φ[n]” represents the distance traveled by the driver's vehicle 18 in the width direction A per unit time. A width direction distance Sx[n] at a specific time in Expression (3) is represented by an integrated value obtained by integrating the distance traveled in the width direction A per unit time from the time of entry into the intersection 12 until the specific time (time in n-th unit time). This Sx[n] can be calculated using a vehicle speed V[n] and a yaw rate YR[n] per unit time as well as Δn.

The second driver's vehicle position calculation unit 56 calculates the width direction distance Sx[n] with respect to the reference coordinates at a specific time corresponding to the n-th unit time based on the vehicle speed V[n] and the yaw rate YR[n] per unit time included in the vehicle behavior information and Δn stored in advance in the storage unit 64. The second driver's vehicle position calculation unit 56 calculates the width direction distance Sx[n] using Expressions (1) to (3). The output from the vehicle speed sensor 40A is used for the vehicle speed, and the output from the yaw rate sensor 40D is used for the yaw rate. The second driver's vehicle position calculation unit 56 calculates this width direction distance Sx[n] as driver's vehicle position information at the specific time.

The section determination unit 58 determines whether or not the driver's vehicle has made a right or left turn and exited the intersection 12 based on the section position information obtained by the first information acquisition unit 48 and the driver's vehicle position information calculated by the second driver's vehicle position calculation unit 56, as follows.

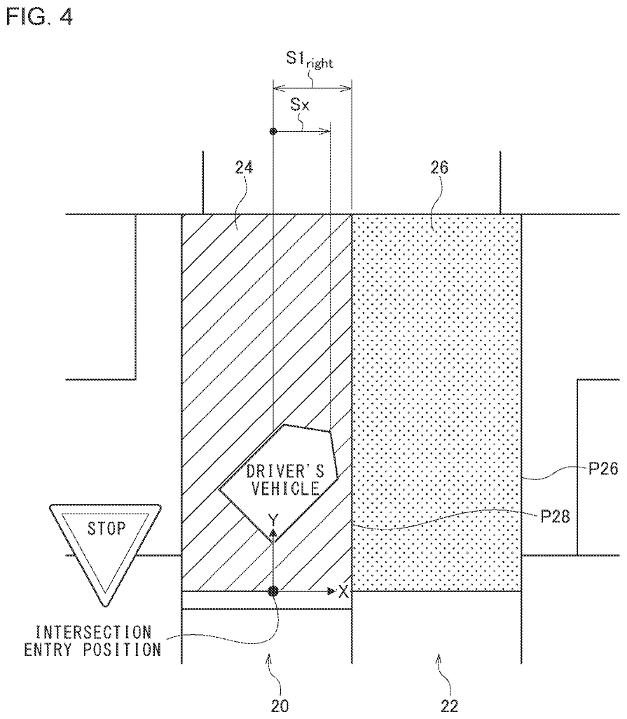

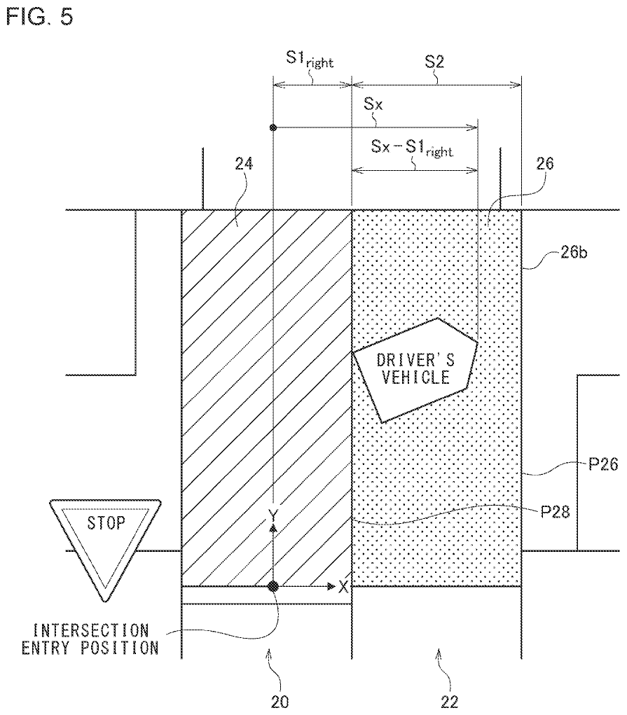

FIGS. 4 and 5 are illustration diagrams of the driver's vehicle position and the width direction distance Sx during a right turn. First, the section determination unit 58 derives the distance S1_{right} from the intersection entry position to the section boundary position P28 and the distance S2 from the section boundary position P28 to the end position P26 of the second section 26. For the distance S1_{right}, the distance in the width direction from the section boundary position P28 to the driver's vehicle position calculated most recently by the first driver's vehicle position calculation unit 50 when the driver's vehicle is determined to have entered the intersection 12 by the entry determination unit 52. The distance S2 represents the width of the entire oncoming lane 22. If there is a center line 72, the distance S2 is the distance from the end position of the oncoming lane 22 side of the driver's vehicle traveling way 10 to the center line 72, and if there is no center line 72, the distance S2 is the value obtained by bisecting the width L1 of the driver's vehicle traveling way 10. The distance S2 is derived in both cases using the section position information. Also, the section determination unit 58 derives the sum of the distance S1_{right} and the distance S2 (=S1_{right}+S2). This sum represents the distance from the intersection entry position to the second exit 26b of the second section 26.

The section determination unit 58 determines that the driver's vehicle has made a right turn and exited the intersection 12 when Sx serving as the driver's vehicle position information is positive and exceeds (S1_{right}+S2) that has been derived. The section determination unit 58 determines that the driver's vehicle has exited the intersection 12 as described above when the driver's vehicle position (Sx) identified by the driver's vehicle position information exceeds the exit position (S1_{right}+S2) of the second section 26, which is derived using the intersection entry position and the section position information.

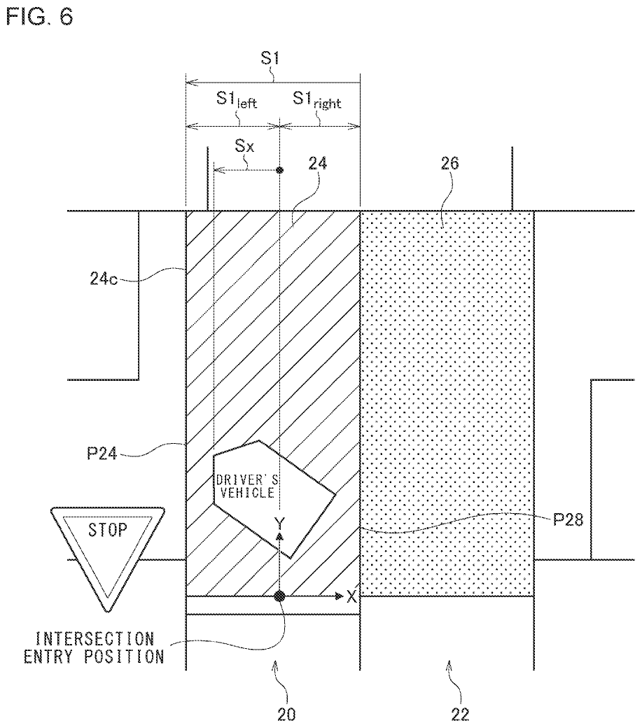

FIG. 6 is an illustration diagram of the driver's vehicle position and the width direction distance Sx during a left turn. The section determination unit 58 derives the distance S1_{left} from the intersection entry position to the end position P24 of the first section 24. The distance S1_{left} can be calculated using a value obtained by subtracting the above-mentioned distance S1_{right} from the distance S1 to the section boundary position P28 from the end position P24 of the first section 24. If there is a center line 72, the distance S1 is the distance from the end position of the traveling lane 20 side of the driver's vehicle traveling way to the center line 72, and if there is no center line 72, the distance S1 is a value obtained by bisecting the width L1 of the driver's vehicle traveling way 10. The distance S1 is derived in both cases using the section position information. The distance S1_{left} represents the distance from the intersection entry position to the second exit 24c of the first section 24.

The section determination unit 58 determines that the driver's vehicle has made a left turn and exited the intersection 12 when Sx serving as the driver's vehicle position information is negative and |Sx|exceeds |S1_{left}| that has been derived. The section determination unit 58 determines that the driver's vehicle has exited the intersection 12 as described above when the driver's vehicle position (Sx) identified by the driver's vehicle position information exceeds the exit position (S1_{left}) of the first section 24, which is derived using the intersection entry position and the section position information.

If Sy[n] serving as the driver's vehicle position information exceeds the end position of the of the first section 24 in the traveling direction, which is set in advance, the section determination unit 58 determines that the driver's vehicle has travelled straight ahead without making a right or left turn.

If the section determination unit 58 determines that the driver's vehicle has made a right or left turn and exited the intersection 12, the section determination unit 58 performs the next section determination process. Based on the section position information, the section determination process determines which of the first section 24 and the second section 26 the driver's vehicle position at each time identified by the driver's vehicle position information is located, as follows.

FIG. 4 is referred back. If the section determination unit 58 determines that the driver's vehicle has made a right turn, the section determination unit 58 determines that the driver's vehicle position, which is at the distance Sx[n], is in the first section 24 when the distance Sx[n] is less than or equal to the distance S1_{right}. In other words, if the driver's vehicle position (Sx[n]) identified by the driver's vehicle position information does not exceed the section boundary position (S1_{right}), the section determination unit 58 determines that the driver's vehicle position is in the first section 24.

FIG. 5 is referred back. If the section determination unit 58 determines that the driver's vehicle has made a right turn, the section determination unit 58 determines that the driver's vehicle position, which is at the distance Sx, is in the second section 26 when the difference value between distance Sx[n] and distance S1_{right} (=Sx−S1_{right}) exceeds zero and is less than or equal to the distance S2. In other words, if the driver's vehicle position (Sx[n]) identified by the driver's vehicle position information exceeds the section boundary position (S1_{right}) but does not exceed the end position (S1_{right}+S2) of the second section 26, the section determination unit 58 determines that the driver's vehicle position is in the second section 26.

FIG. 6 is now referred to. If the section determination unit 58 determines that the driver's vehicle has made a left turn, the section determination unit 58 determines that the driver's vehicle position, which is at the distance Sx, is in the first section 24 when the absolute value |Sx[n]| of the distance Sx[n] is less than or equal to the absolute value |S1_{left}| of the distance S1_{left}. In other words, when the driver's vehicle position (|Sx[n]|) identified by the driver's vehicle position information does not exceed the end position (1S_{left}|) of the first section 24, the section determination unit 58 determines that the driver's vehicle position is in the first section 24.

The extraction unit 60 extracts a specific driving characteristic parameter corresponding to at least one of the first section 24 and the second section 26 from the history information based on the result of the determination by the section determination unit 58. For example, if the section determination unit 58 determines that the driver's vehicle position at a certain time is in the first section 24, the extraction unit 60 treats a driving characteristic parameter acquired at that time as corresponding to the first section 24 and acquired in the first section 24. Further, if the section determination unit 58 determines that the driver's vehicle position at a certain time is in the second section 26, the extraction unit 60 treats a driving characteristic parameter acquired at that time as corresponding to the second section 26 and acquired in the second section 26.

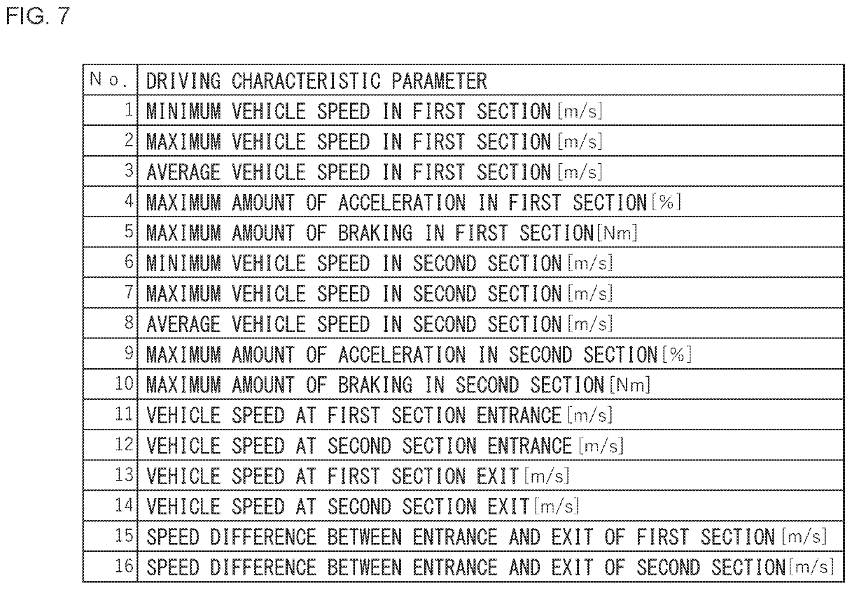

FIG. 7 shows examples of specific driving characteristic parameters to be extracted by the extraction unit 60. The units in FIG. 7 are examples. Each of “minimum vehicle speed in first section,” “maximum vehicle speed in first section,” “minimum vehicle speed in second section,” and “maximum vehicle speed in second section” refers to a vehicle speed that has an extreme value (maximum or minimum value) among multiple vehicle speeds acquired in a section being mentioned. Each of “maximum amount of acceleration in first section” and “maximum amount of acceleration in second section” refers to the amount of acceleration that has an extreme value (maximum value) among multiple amounts of acceleration acquired in a section being mentioned. Each of “maximum amount of braking in first section” and “maximum amount of braking in second section” refers to the amount of braking that has an extreme value (maximum value) among multiple amounts of braking acquired in a section being mentioned. The extraction unit 60 can acquire these by extracting from the history information the driving characteristic parameters with extreme values among multiple driving characteristic parameters of the same type acquired in a section from which the driving characteristic parameters are extracted.

“Vehicle speed at first section entrance” and “vehicle speed at second section entrance” refer to vehicle speeds acquired immediately after entering the entrance of a section being mentioned, among multiple vehicle speeds acquired in the section. “Vehicle speed at first section exit” and “vehicle speed at second section exit” refer to vehicle speeds acquired immediately before exiting the exit of a section being mentioned, among multiple vehicle speeds acquired in the section. The specific driving characteristic parameters up to this point can be obtained by extracting the specific driving characteristic parameters themselves from multiple driving characteristic parameters stored in the history information.

“Average vehicle speed in first section” and “average vehicle speed in second section” each refer to the average value of multiple vehicle speeds acquired in a section being mentioned. The extraction unit 60 can obtain these by extracting all the vehicle speeds acquired in a section from which the driving characteristic parameters are extracted, calculating the average value of all the extracted vehicle speeds, and extracting the calculated value as the average vehicle speed to be extracted.

“Speed difference between entrance and exit of first section” and “speed difference between entrance and exit of second section” are each the difference between the aforementioned entrance and exit vehicle speeds acquired in a section being mentioned. The extraction unit 60 can obtain these by extracting the entrance vehicle speeds and the exit vehicle speeds from among multiple vehicle speeds acquired in the respective sections from which the driving characteristic parameters are extracted, obtaining the differences between the respective extracted entrance vehicle speeds and exit vehicle speeds, and extracting the differences as speed differences to be extracted.

When it is determined by the section determination unit 58 that the driver's vehicle has made a right turn, the extraction unit 60 extracts driving characteristic parameters related to the first section 24 and the second section 26 described in FIG. 7 as driving characteristic parameters corresponding to the driving behavior. In the present embodiment, a total of sixteen driving characteristic parameters in FIG. 7 are extracted. When it is determined by the section determination unit 58 that the driver's vehicle has made a left turn, the extraction unit 60 extracts driving characteristic parameters related to the first section 24 described in FIG. 7 as driving characteristic parameters corresponding to the driving behavior. In the present embodiment, a total of eight driving characteristic parameters in FIG. 7 are extracted.

The evaluation unit 62 performs a driving behavior evaluation process for evaluating the driving behavior of the driver based on the driving characteristic parameters extracted by the extraction unit 60. In this driving behavior evaluation process, a driving behavior evaluation model 68 corresponding to either of a right turn and a left turn determined by the section determination unit 58 is read from the storage unit 64. Next, the driving characteristic parameters extracted by the extraction unit 60 are input to the driving behavior evaluation model 68 that has been read, and the degree of safety of the driving behavior of either a right or left turn is evaluated using the output of the driving behavior evaluation model 68.

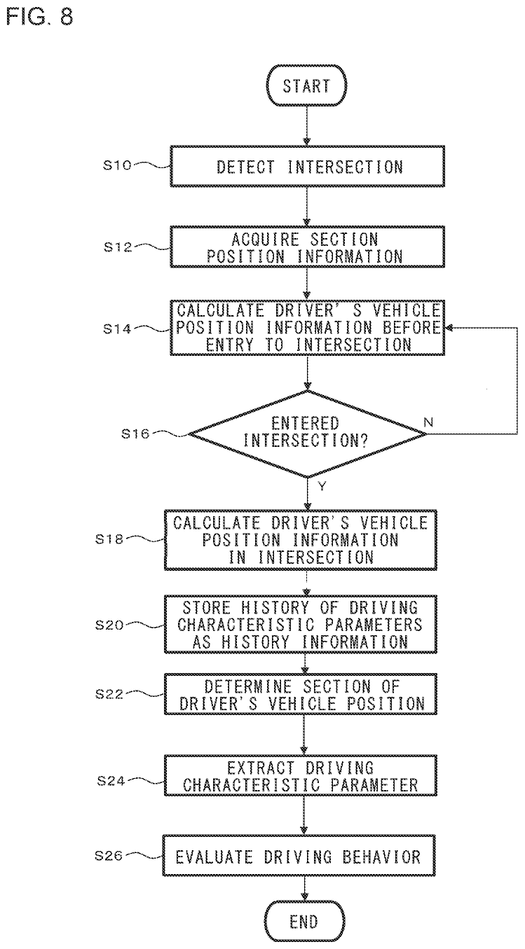

Next, the overall operation of the information processor 30 described above will be explained. FIG. 8 is a flowchart showing a parameter extraction process and a driving behavior evaluation process performed by the information processor 30.

First, the parameter extraction process is explained. The detection unit 46 detects the presence or absence of the intersection 12 in front of the driver's vehicle (S10). The detection unit 46 according to the present embodiment detects the presence of the temporary stop intersection 12 by detecting the stop line 14 and the temporary stop sign 16 located in front of the driver's vehicle based on an image acquired by the image acquisition unit 44. The first information acquisition unit 48 acquires section position information when the intersection 12 is detected by the detection unit 46 (S12). The first driver's vehicle position calculation unit 50 calculates the distance in the width direction from the section boundary position P28 to the driver's vehicle position before entering the intersection (S14). The entry determination unit 52 determines whether the driver's vehicle has passed the stop line 14 and entered the intersection 12 (S16). If the entry determination unit 52 determines that the driver's vehicle has not entered the intersection 12 (N in S16), the distance in the width direction from the section boundary position P28 to the driver's vehicle position is repeatedly calculated by the first driver's vehicle position calculation unit 50 until the driver's vehicle is determined to be entering the intersection 12.

When it is determined by the entry determination unit 52 that the driver's vehicle has entered the intersection 12 (Y in S16), the second driver's vehicle position calculation unit 56 sequentially calculates the driver's vehicle position information in the intersection 12 based on the vehicle behavior information sequentially acquired by the second information acquisition unit 54 (S18). The second information acquisition unit 54 stores the history of driving characteristic parameters included in the vehicle behavior information when traveling through the intersection as history information in the storage unit 64 (S20). When the section determination unit 58 determines that the driver's vehicle is turning a right or left, the section determination unit 58 determines which of the first section 24 and the second section 26 the driver's vehicle position identified by the driver's vehicle position information is located (S22). The extraction unit 60 extracts a specific driving characteristic parameter corresponding to at least one of the first section 24 and the second section 26 from the history information based on the result of the determination by the section determination unit 58 (S24). This completes the parameter extraction process. Next, the evaluation unit 62 performs a driving behavior evaluation process for evaluating the driving behavior based on the driving characteristic parameters that have been extracted (S26). The process is ended after this.

The information processor 30 described above can extract specific driving characteristic parameters corresponding to the first section 24 on the traveling lane 20 and the second section 26 on the oncoming lane 22 from the history information, which is the history of driving characteristic parameters acquired when driving through the intersection, based on the result of the determination by the section determination unit 58. Therefore, driving characteristic parameters for each of the traveling lane 20 and the oncoming lane 22 at the intersection 12 can be separately acquired.

By using the vehicle speed and yaw rate of the driver's vehicle as vehicle behavior information, the distance in the wide direction can be calculated from the intersection entry position to the driver's vehicle position as the driver's vehicle position information by adding up the traveling distance in the width direction for each unit time.

The vehicle speed and yaw rate output from the sensor are used to calculate the distance in the width direction from the intersection entry position to the driver's vehicle position as the driver's vehicle position information. Therefore, the distance in the width direction serving as the driver's vehicle position information can be calculated more accurately than in the case where the driver's vehicle position information is calculated using GPS, which has a large error rate.

A case is now assumed that the driving behavior is evaluated using the driving characteristic parameters that can be acquired when passing through a fixed point that is a specific distance away from a reference position using the distance from the reference position (for example, intersection entry position). In this case, depending on the size of the width of the intersection 12, the driving operation when passing through the fixed point (particularly a fixed point on oncoming lane 22), where the driving characteristic parameters are acquired, is likely to change significantly, and the size of the driving characteristic parameters is likely to change accordingly. Therefore, the correlation between the driving characteristic parameters acquired when passing through the fixed point and an index value for evaluating driving behavior tends to become weak, making it difficult to accurately evaluate driving behavior using the driving characteristic parameters.

In this respect, according to the present embodiment, driving characteristic parameters with extreme values are extracted from among multiple driving characteristic parameters of the same type acquired in a section from which the driving characteristic parameters are extracted. The size of the extreme values of the driving characteristic parameters is unlikely to change depending on the width of the intersection, and the correlation with the index value that evaluates the driving behavior tends to become stronger. Therefore, regardless of the size of the width of the intersection, the driving behavior is more easily evaluated with good accuracy using the driving characteristic parameters that have extreme values in a section.

Described above is an explanation of the present disclosure based on the embodiments. The embodiments are intended to be illustrative only, and it will be obvious to those skilled in the art that various modifications to constituting elements and processes could be developed and that such modifications are also within the scope of the present disclosure. Also, substitutions of any of the constituting elements and expressions of the present disclosure among methods, devices, systems, etc., are also valid as aspects of the present disclosure.

The example has been explained thus far where an information processor 30 is used when passing through an intersection by making a right or left turn in a country with left-hand traffic. Alternatively, an information processor 30 may be used when passing through an intersection by making a right or left turn in a country with right-hand traffic. In this case, the details described in the embodiment need to be treated on the assumption that the left-right positional relationship is reversed. For example, “right turn” written in the embodiment should be replaced with “left turn”, and “left turn” should be replaced with “right turn”.

The example has been explained in which the program 66 is stored (installed) in advance in the storage unit 64. Alternatively, the program 66 may be stored in a storage medium such as a DVD-ROM.

The number of types of driving characteristic parameters to be input to the driving behavior evaluation model 68 is not particularly limited. Only some of the driving characteristic parameters explained in the embodiment may be used as input, or other driving characteristic parameters may also be used as input. It can be considered that the second information acquisition unit 54 may store the history of driving characteristic parameters other than the multiple types of driving characteristic parameters explained in the embodiment as history information.

The example has been explained in which the parameter extraction process and the driving behavior evaluation process are executed by the information processor 30 of the in-vehicle system 34. Alternatively, the parameter extraction process and driving behavior evaluation process may be executed by the server 36. In this case, the functions of the information processor 30 are executed by the server 36. Further, the parameter extraction process may be executed by a first information processor (e.g., the information processor 30 of the in-vehicle system 34), and the driving behavior evaluation process may be executed by a second information processor (e.g., the server).

The driving behavior evaluation process may be executed immediately after the completion of the parameter extraction process as in the embodiment, or may be executed at any time after the completion of the parameter extraction process. The information processor 30 is not limited to be used for a temporary stop intersection 12 with a temporary stop regulation but may be used for an intersection 12 without a temporary stop regulation. The driver's vehicle may be a self-driving vehicle.

What is claimed is:

1. An information processor comprising:
a first information acquisition unit that acquires section position information for identifying a position of a first section on a traveling lane for the traveling of a driver's vehicle and a position of a second section on an oncoming lane at an intersection located in front of the driver's vehicle;
a second information acquisition unit that sequentially acquires vehicle behavior information regarding behavior of the driver's vehicle when traveling through the intersection and stores, as history information, a history of driving characteristic parameters representing the driving characteristics of the driver included in the sequentially acquired vehicle behavior information;
a driver's vehicle position calculation unit that sequentially calculates the driver's vehicle position information for identifying the driver's vehicle position when traveling through the intersection based on the vehicle behavior information;
a section determination unit that determines which of the first section and the second section the driver's vehicle position identified by the driver's vehicle position information is located, based on the section position information; and
an extraction unit that extracts a specific driving characteristic parameter corresponding to at least one of the first section and the second section from the history information based on the result of the determination by the section determination unit.

2. The information processor according to claim 1, wherein a boundary position between the first section and the second section is identified as a center line located between the traveling lane and the oncoming lane or a position obtained by extending a position bisecting the width of the driver's vehicle traveling way to the intersection.

3. The information processor according to claim 1, wherein
the vehicle behavior information includes the vehicle speed and the yaw rate of the driver's vehicle,
the driver's vehicle position information represents a distance in the width direction from an entry position to the intersection to the driver's vehicle position, and
the driver's vehicle position calculation unit calculates an integrated value obtained by integrating a distance traveled in the width direction per unit time from the time of entry into the intersection until a specific time as the distance in the width direction at the specific time based on the vehicle speed and the yaw rate.

4. The information processor according to claim 3, wherein each of the vehicle speed and the yaw rate is output from a sensor mounted on the driver's vehicle.

5. The information processor according to claim 1, wherein from among multiple driving characteristic parameters of the same type acquired in a section from which the driving characteristic parameter is extracted, the extraction unit extracts driving characteristic parameters with extreme values.

6. The information processor according to claim 1, comprising an evaluation unit that evaluates the driving behavior of the driver based on the driving characteristic parameter extracted by the extraction unit.

7. An information processing method executed by a computer, comprising:
acquiring section position information for identifying a position of a first section on a traveling lane for the traveling of a driver's vehicle and a position of a second section on an oncoming lane at an intersection located in front of the driver's vehicle;
sequentially acquiring vehicle behavior information regarding behavior of the driver's vehicle when traveling through the intersection and storing, as history information, a history of driving characteristic parameters representing the driving characteristics of the driver included in the sequentially acquired vehicle behavior information;
sequentially calculating the driver's vehicle position information for identifying the driver's vehicle position where the driver's vehicle exists when traveling through the intersection based on the vehicle behavior information;
determining which of the first section and the second section the driver's vehicle position identified by the driver's vehicle position information is located, based on the section position information; and
extracting a specific driving characteristic parameter corresponding to at least one of the first section and the second section from the history information based on the result of the determination in the determining.

8. A recording medium having embodied thereon a program comprising computer-implemented modules including:
a module that acquires section position information for identifying a position of a first section on a traveling lane for the traveling of a driver's vehicle and a position of a second section on an oncoming lane at an intersection located in front of the driver's vehicle;
a module that sequentially acquires vehicle behavior information regarding behavior of the driver's vehicle when traveling through the intersection and stores, as history information, a history of driving characteristic parameters representing the driving characteristics of the driver included in the sequentially acquired vehicle behavior information;
a module that sequentially calculates the driver's vehicle position information for identifying the driver's vehicle position where the driver's vehicle exists when traveling through the intersection based on the vehicle behavior information;
a determination module that determines which of the first section and the second section the driver's vehicle position identified by the driver's vehicle position information is located, based on the section position information; and
a module that extracts a specific driving characteristic parameter corresponding to at least one of the first section and the second section from the history information based on the result of the determination by the determination module.
